(19) United States
(12) Patent Application Publication
(10) Pub. No.: US 2016/0036071 A1
(43) Pub. Date: Feb. 4, 2016

(54) COOLING CONCEPT FOR A FUEL CELL SYSTEM FOR A VEHICLE AND AIRCRAFT HAVING SUCH A FUEL CELL SYSTEM

(71) Applicant: Airbus Operations GmbH, Hamburg (DE)

(72) Inventors: Guido KLEWER, Hamburg (DE); Hauke-Peer LUEDDERS, Hamburg (DE)

(21) Appl. No.: 14/811,198

(22) Filed: Jul. 28, 2015

(30) Foreign Application Priority Data
Jul. 30, 2014 (EP) 14 179 124.4

(51) Int. Cl. H01M 8/04; B64D 41/00

(52) U.S. Cl. CPC H01M 8/04074; H01M 8/04029; B64D 41/00; H01M 2250/20; B64D 2041/005

(57) ABSTRACT

A fuel cell system for a vehicle comprises at least one fuel cell, at least one fuel cell heat exchanger arranged in or at the at least one fuel cell for receiving heat of the at least one fuel cell, at least one thermal dissipation unit, at least one additional heat exchanger and a cooling loop having a plurality of fluid line segments for conveying a coolant. The at least one fuel cell heat exchanger is coupled with the at least one thermal dissipation unit through the cooling loop, and the additional heat exchanger is arranged in the cooling loop and is adapted for receiving heat from an external source and for raising the temperature of a coolant flowing in the cooling loop.

### CROSS-REFERENCE TO RELATED APPLICATION

This application claims priority of European Patent Application No. 14 179 124.4, filed Jul. 30, 2014, which is incorporated herein by reference in its entirety.

### TECHNICAL FIELD

The embodiments described herein relate to a fuel cell system for a vehicle and aircraft having such a fuel cell system.

### BACKGROUND

Today's aircraft are often equipped with separate systems for emergency power supply and cargo fire suppression. For a so-called “total engine flame out” (TEFO) situation or the loss of a main electrical power supply (LMES), a ram air turbine for providing emergency power is designated. Ram air turbines are capable of providing sufficient power when the speed of the impinging ram air is sufficient. However, this may be critical in a phase close to touchdown during the landing phase of the aircraft.

For extinguishing or suppressing a fire in a cargo compartment of an aircraft, Halon fire extinguishers were often used. Due to adverse effects of Halon on the ozone layer and since the use of Halon will be limited by authorities, a replacement for Halon is necessary.

It is an object to provide an emergency power system in an aircraft based on a fuel cell that generates electrical power and, as by-products, thermal power, water and, if air is used as an oxidant, oxygen depleted air. If the remaining oxygen content in the cathode air is reduced to approximately 12%, this oxygen depleted air is usable for suppressing fire in the event of a fire on board or be used for fuel tank inerting in order to increase the safety of the fuel system.

The thermal power needs to be disposed of the fuel cell in order to maintain an accurate operation. It is known to use air cooling or liquid cooling. In particular, in aircraft installations, it is known to use cooling loops coupled with a centralized heat sink for cooling equipment with a certain thermal load.

In addition, other objects, desirable features and characteristics will become apparent from the subsequent summary and detailed description, and the appended claims, taken in conjunction with the accompanying drawings and this background.

### SUMMARY

It is an object of the embodiments described herein to propose an alternate cooling system capable of cooling a fuel cell system, wherein the cooling system is significantly lower in weight and simpler to setup.

The object is met by a fuel cell system comprising the features recited in claim 1. Advantageous embodiments and further improvements may be gathered from the sub-claims and the following description.

A fuel cell system for a vehicle is proposed, the fuel cell system comprising at least one fuel cell, at least one fuel cell heat exchanger arranged in or at the at least one fuel cell for receiving heat of the at least one fuel cell, at least one thermal dissipation unit, an additional heat exchanger and a cooling loop having a plurality of fluid line segments for conveying a coolant. The at least one fuel cell heat exchanger is coupled with the at least one thermal dissipation unit through the cooling loop. The additional heat exchanger is arranged in the cooling loop and is adapted for receiving heat from an external source and for raising the temperature of a coolant flowing in the cooling loop.

The fuel cell may be realized by means of a single fuel cell, a fuel cell stack having a plurality of interconnected fuel cells or an arrangement of fuel cells or fuel cell stacks in a series or parallel connection. Several fuel cell types may be used for the fuel cell system according to the embodiments, which may include a low temperature, a medium temperature or a high temperature fuel cell type that produces electricity and heat as well as water, which arises at a cathode side of the at least one fuel cell. In vehicle installations, polymer electrolyte membrane fuel cells with a low or medium temperature range may be preferred.

To dispose of heat from the at least one fuel cell, at least one dedicated fuel cell heat exchanger is arranged in or at the at least one fuel cell. This does not necessarily mean that the fuel cell heat exchanger is a separate device, as it may be realized by cooling channels in the fuel cell or a certain design of a housing of the at least one fuel cell. Resultantly, heat that arises during the fuel cell process is transferred to the coolant flowing in the cooling loop. The sizing of the fuel cell heat exchanger depends on the temperature level and the intended flow rate of the coolant in order to not exceed a predetermined maximum temperature, depending on the type of the at least one fuel cell. Most preferably, the at least one fuel cell heat exchanger is an integrated component of the at least one fuel cell, which may be incorporated into a compact fuel cell package.

The at least one thermal dissipation unit may be any device capable of dissipating heat from the coolant into the surrounding of the vehicle, thereby lowering the temperature level of the coolant, which may then flow back to the fuel cell heat exchanger for further cooling. A plurality of different types of thermal dissipation units are imaginable, which comprise heat exchangers for dissipating heat into an airflow surrounding the vehicle, into at least one compartment or interior space where the at least one fuel cell and/or the heat dissipation unit is installed, a liquid-liquid heat exchanger for dissipation of heat into a liquid reservoir, such as a fuel tank or a hydrogen tank, etc. If the fuel cell system is able to provide emergency power sufficient for safe operation of the vehicle in case of a failure of primary power sources, the thermal dissipation unit may provide a sufficient amount of cooling power, preferably achievable through a liquid-air heat exchanger.

The additional heat exchanger may be coupled to any heat load, i.e. any device that generates heat inside the vehicle and that requires cooling. A feature of the embodiments lie in that the additional heat exchanger raises the temperature of the coolant inside the cooling loop, which leads to an increased temperature difference between a heat sink thermally coupled with the thermal dissipation unit and the coolant flowing in the cooling loop. Preferably, the additional heat exchanger is thermally coupled with another component of the fuel cell system, such that the integration into a single cooling loop leads to an improved system reliability as well as a strictly limited weight. The higher the temperature of the coolant at a coolant inlet of the thermal dissipation unit is, the less active surface and consequently the less weight of the thermal dissipation unit is necessary. In the following, a power electronics heat exchanger is described, which may be one of the at least one additional heat exchanger. Also, a cathode reactant gas heat exchanger, which is mentioned below, may also be one of the at least one additional heat exchanger.

In an advantageous embodiment, the fuel cell system further comprises a power electronics unit for the control and conversion of electrical power of the at least one fuel cell, wherein the power electronics comprises a power electronics heat exchanger arranged as an additional heat exchanger or at the power electronics unit for receiving heat of the power electronics unit and wherein the power electronics heat exchanger is arranged in the cooling loop upstream of the at least one fuel cell heat exchanger. During the operation of the power electronics, which may be necessary for providing a sufficient voltage level for the devices that are supplied with power from the fuel cell system, heat is generated. For maintaining the operation of the power electronics unit and for preventing overheating or damage to the components in the power electronics, sufficient cooling is necessary. By integrating the power electronics heat exchanger into the cooling loop of the fuel cell system, a combined cooling is possible and a separate cooling system for the power electronics unit is not necessary. Still further, due to the fact that the fuel cell heat exchanger may transfer a large amount of heat to the cooling loop, while the at least one additional heat exchanger may only transfer a relatively small amount of heat, the temperature spreading of the coolant in the cooling loop is more efficiently used than in separate cooling loops for the fuel cell heat exchanger and the additional heat exchanger alone. Also, the total weight of the components and the coolant necessary for cooling is reduced in comparison to separate cooling loops.

An advantageous embodiment further comprises a coolant bypass parallel to the power electronics heat exchanger for bypassing the power electronics heat exchanger at least with a part of the coolant flow. Hence, it is not necessary to lead the total coolant flow through the power electronics heat exchanger if the demand for cooling power differs in comparison with the at least one fuel cell. The coolant bypass may simply be a coolant line arranged parallel to the power electronics heat exchanger. Hence, pressure losses may be reduced. Further, weight may be saved since fluid channels may be smaller in the power electronics heat exchanger.

It may also be feasible to provide at least one valve for adjusting the flow rate through the coolant bypass or for selectively opening and closing the coolant bypass. The latter may be conducted in a certain interval or simply in cases where a low cooling power demand for the power electronics unit arises.

In a still further advantageous embodiment, a cathode reactant gas heat exchanger as an additional heat is present, which is arranged in the cooling loop downstream of the at least one fuel cell heat exchanger, wherein the cathode reactant gas heat exchanger is adapted for being flown through by air supplied to a cathode of the at least one fuel cell. In general, the at least one fuel cell may consume hydrogen and oxygen. The oxygen may be delivered in the form of oxygen containing air, for avoiding excessive weight or complexity due to separate oxygen storage and supply means, especially for installation in an aircraft. It is desirable to provide air having a certain pressure level, which may clearly exceed the ambient pressure of the region or compartment in which the fuel cell system is installed. For example, the pressure of the air supply may be 50% over the ambient pressure. Hence, due to the compression, the air delivered to the fuel cell system may have an elevated temperature. By flowing through the cathode, reactant gas heat exchanger, the air is cooled. Consequently, the temperature level of the air supplied to the fuel cell system is adjusted to a suitable temperature for the fuel cell cathode, and the coolant temperature is raised. Hence, besides improving the heat transfer in the thermal dissipation unit, a separate pre-cooler for the air supply may be eliminated.

In an advantageous embodiment, the fuel cell system further comprises a source of compressed air coupled with a cathode side of the at least one fuel cell. In particular in aircraft applications, the source of compressed air may be realized through a bleed air port, which may already be present for supplying an environmental control system or any other bleed air consuming devices. The bleed air may already be pre-cooled and expanded to a certain pressure level suitable for use in the at least one fuel cell. As an alternative, the source of compressed air may include an air inlet and a compressor, that compresses the air taken in through the air inlet.

In an advantageous embodiment, the thermal dissipation unit may be arranged in a ram air channel. Consequently, during the operation of the vehicle, in which the fuel cell system is installed, an airflow may pass through or above the thermal dissipation unit when the vehicle is in motion, thereby clearly increasing the heat transfer. Resultantly, a reliable cooling is accomplished.

In this regard, for improving the heat transfer in situations in which the vehicle is not in motion and in which no airflow is present in the ram air channel, an air conveying means may be used for providing a certain air flow. This supports the heat transfer in the ram air channel. For example, a fan may be arranged in the ram air channel, which fan may be operated when this situation occurs, especially when the engines of the vehicle are not operated.

Preferably, the coolant is a liquid coolant comprising glycol and water. Most preferably, the liquid coolant is an ethylene-glycol water mixture. The coolant resultantly has a freezing protection and a clearly increased boiling point depending on the percentages of water and glycol. These coolants are in widespread use and provide a reliable heat transfer.

It may furthermore be advantageous to pressurize the cooling loop with a certain minimum pressure, such that the boiling point may be shifted to higher temperatures, in order to reliably avoid the boiling point, especially with cooling medium and high temperature fuel cells.

In a particularly advantageous embodiment, a de-ionization filter is arranged in the cooling loop. Thereby, a low coolant electrical conductivity and, consequently, a high fuel cell efficiency is maintained. Depending on the characteristics of the de-ionization filter, it may be installed parallel to any of the components in the cooling loop or in a serial connection. For example, the cooling loop may comprise a coolant pump, wherein the de-ionization filter may be arranged parallel to the coolant pump in a recirculation path. However, the de-ionization filter may also be positioned inside one of a plurality of branches of the power electronics unit or in a bypass parallel to the power electronics unit. In this regard, an as low as possible additional friction loss arising from the de-ionization filter should be considered.

The embodiments further relate to an aircraft comprising a fuselage and a fuel cell system according to the above description arranged in the fuselage.

In an advantageous embodiment, the aircraft further comprises a ram air channel in the fuselage, wherein the thermal dissipation unit is arranged in the ram air channel. The position of the ram air channel may be chosen according to the general setup or design of the aircraft. For example, such a ram air channel may be arranged in a wing root region or at an underside of the fuselage.

Still further the aircraft further comprises at least one interior space in the fuselage, wherein the thermal dissipation unit is arranged in the interior space and is adapted to dissipate heat into the interior space heating up this space using the thermal capacity of this space, including all installations therein. Especially when the fuel cell system is arranged in a pressurized part of the fuselage, it may be advantageous to also conduct the required cooling in this part of the fuselage. However, the fuel cell system may also be placed in an unpressurized part of the fuselage, and the embodiments are not limited to where the fuel cell system is installed. In this regard, it is indicated that especially in larger commercial aircraft, pressurized spaces comprise a large volume and a large wall surface dividing the pressurized space from the surrounding of the aircraft. During the normal operation of the aircraft, the ambient temperature is usually clearly lower than the temperature inside the pressurized space. For this purpose, a thermal insulation is arranged on the fuselage to reduce the heat transfer from inside the pressurized space to the outside. However, providing an additional heat load in the pressurized space through the thermal dissipation unit, the temperature inside the pressurized space may only rise insignificantly, but due to the large wall surface, a reliable dissipation into the ambient can be accomplished. In this regard, a cargo compartment in an aircraft suggests itself due to the lack of heat load from passengers. However, this may also apply to an unpressurized, but ventilated interior space.

### BRIEF DESCRIPTION OF THE DRAWINGS

The various embodiments will hereinafter be described in conjunction with the following drawing figures, wherein like numerals denote like elements, and:

FIG. 1 shows a fuel cell system in a schematic, block-oriented view in accordance with an embodiment; and

FIG. 2 shows an aircraft having a fuselage and a fuel cell system in accordance with an embodiment installed therein.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

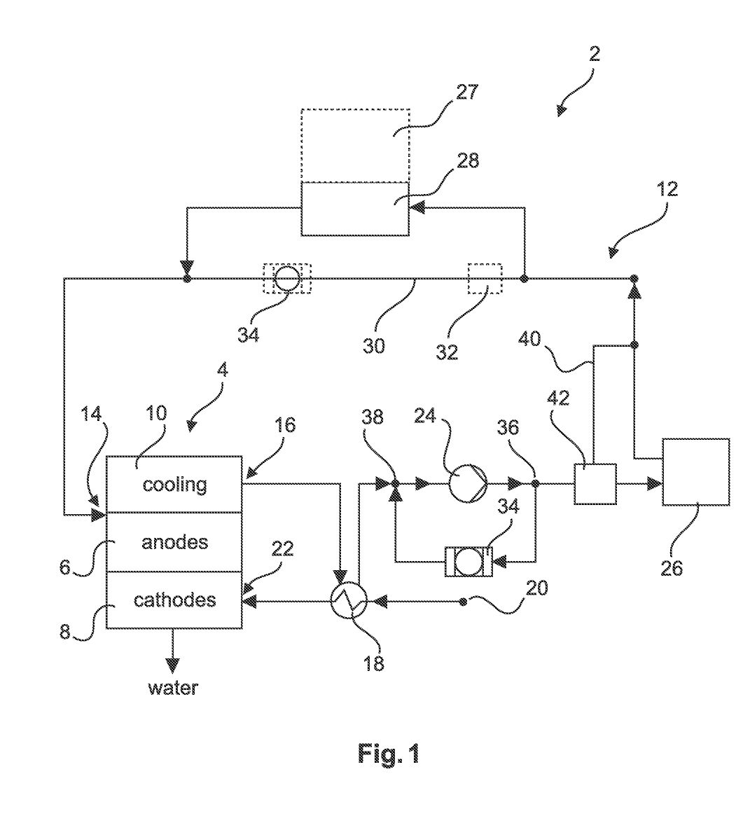

FIG. 1 shows a fuel cell system 2 according to an embodiment. A fuel cell 4 in form of a fuel cell stack is provided, which comprises an anode section 6 and a cathode section 8 as well as a fuel cell heat exchanger 10 thermally coupled with the anode section 6 and the cathode section 8. As a focus of the embodiment lies in the cooling, hydrogen supply is neglected in this figure.

For cooling, a cooling loop 12 is provided that which a coolant flows. For example, coolant flows into a coolant inlet 14 of the fuel cell heat exchanger 10, receives heat from the fuel cell 4, and exits the fuel cell heat exchanger 10 through a coolant outlet 16. Further downstream, a cathode reactant gas heat exchanger 18 is present, through which the coolant flows.

In the cathode reactant gas heat exchanger 18, air from a compressed air source 20 flows through into an air inlet 22 of the cathode section 8. Resultantly, the coolant flowing from the coolant outlet 16 receives a further amount of heat and reaches an even higher temperature. This is caused by the elevated temperature of the air from the compressed air source 20, which may be a compressor or a bleed air port, that provide air at an elevated pressure, in a range of 50% or higher above the ambient pressure faced by the fuel cell system 2. Hence, the air entering the air inlet 22 of the cathode section 8 is cooled, leading to improved performance and reducing the thermal stress on the fuel cell 4.

In this regard, it is noted that in some cases, which only seldomly occur, air from the pressurized air source 20 may be clearly cooler than the coolant in the cooling loop 12. In the cathode reactant gas heat exchanger 18, this air is then heated up slightly, which, again, reduces the thermal stress of the fuel cell 4 and clearly improves its reliability and performance.

Downstream of the cathode reactant gas heat exchanger 18 in the coolant loop 12, a pump 24 is arranged, which is adapted for conveying the coolant in the coolant loop. Downstream of pump 24, a thermal dissipation unit 26 is provided, which is adapted for dissipating the heat collected in the cooling loop 12 to the surroundings of the thermal dissipation unit 26. This may be a heat exchanger attached to a skin of the aircraft, into a ram air channel or into an interior space of the aircraft. However, it should be noted that a sufficient heat dissipation is accomplished in all possible situations, exemplarily by always maintaining a certain airflow or by maintaining a certain temperature difference between the coolant and the surrounding of the thermal dissipation unit 26.

Coolant exiting the thermal dissipation unit 26 flows back to the coolant inlet 14 of the fuel cell heat exchanger 10. However, a power electronics heat exchanger 28 attached to a power electronics unit 27, which is only schematically indicated by means of dashed lines, may be coupled to the cooling loop 12 in order to provide a sufficient cooling power for the power electronics unit 27 required for controlling and converting the electrical power generated in the fuel cell 4. For adjusting the flow rate through the power electronics heat exchanger 28, a bypass 30 is provided in a parallel connection with the power electronics heat exchanger 28. If desired, and depicted as a dashed box 32, the bypass 30 may comprise a flow control means 32, which is adapted for switching or adjusting the flow rate through the bypass 30.

A de-ionization filter 34 is arranged in a parallel connection to the pump 24 and maintains a low coolant electrical conductivity for maintaining a high fuel cell efficiency. The de-ionization filter 34 may have coolant flowing there through from an inlet port 36 upstream of pump 24 and exiting an outlet port 38 upstream of pump 24. However, such a de-ionization filter 34 may also be provided in the bypass 30, as indicated by dashed box.

Still further, a main bypass 40 having a main bypass valve 42 may be arranged in the cooling loop 12 for bypassing coolant around the thermal dissipation unit 26. The main bypass valve 42 may be able to switch or adjust the flow rate flowing through the main bypass 42. By this arrangement, a temperature control of the coolant in the cooling loop 12 may be achieved.

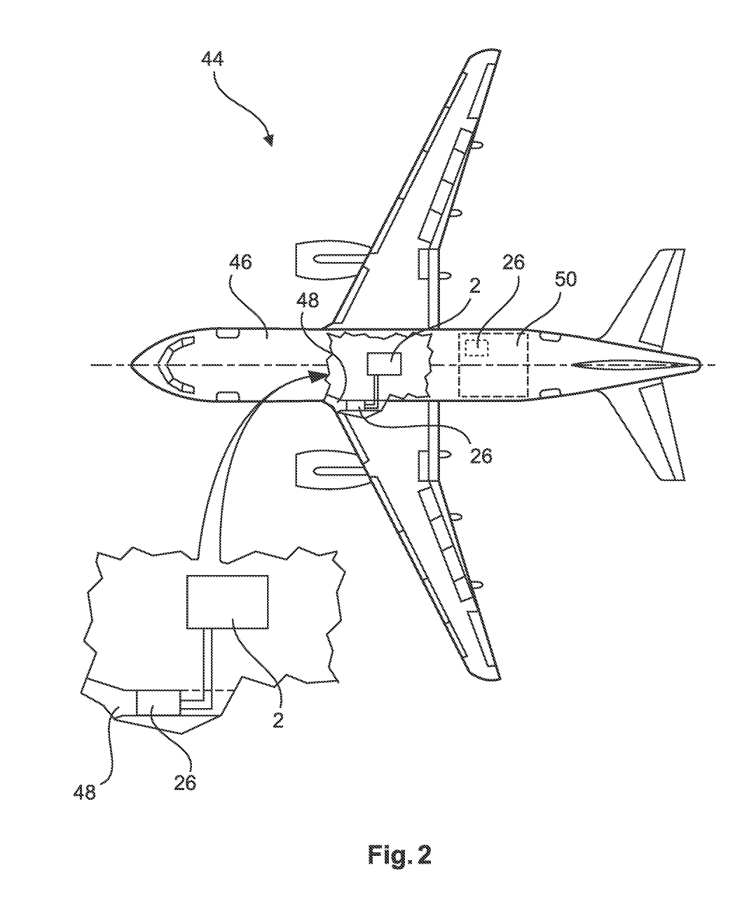

FIG. 2 shows an aircraft 44 having a fuselage 46 and a fuel cell system 2 installed therein. The installation position of the fuel cell system 2 is arbitrarily chosen, but may vary and does not limit the subject-matter herein. A ram air channel 48 may be arranged in a suitable position, such as in a wing root region, which ram air channel 48 may house the thermal dissipation unit 26.

As another exemplary embodiment, the thermal dissipation unit 26 may be arranged in an interior space 50, which is indicated with a dashed line. Again, the schematic view in FIG. 2 shall not limit the subject-matter of the embodiments. It is also conceivable that the space 50 extends along a substantial part of the length of the aircraft 44. For example, the interior space 50 may be a cargo compartment or cargo deck. The thermal dissipation unit 26 may dissipate the heat from the coolant into the interior space in order to heat the air and all installations present in the interior space.

It should be pointed out that “comprising” does not exclude other elements or steps, and “a” or “an” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A fuel cell system for a vehicle, the fuel cell system comprising
at least one fuel cell,
at least one fuel cell heat exchanger arranged in or at the at least one fuel cell for receiving heat of the at least one fuel cell,
at least one thermal dissipation unit,
at least one additional heat exchanger and
a cooling loop having a plurality of fluid line segments for conveying a coolant,
wherein the at least one fuel cell heat exchanger is coupled with the at least one thermal dissipation unit through the cooling loop, and
wherein the additional heat exchanger is arranged in the cooling loop and is adapted for receiving heat from an external source and for raising the temperature of a coolant flowing in the cooling loop.

2. The fuel cell system according to claim 1,
further comprising a power electronics unit for the control and conversion of electrical power of the at least one fuel cell,
wherein the power electronics unit comprises a power electronics heat exchanger arranged in or at the power electronics unit for receiving heat of the power electronics unit, and
wherein the power electronics heat exchanger is arranged in the cooling loop upstream of the at least one fuel cell heat exchanger.

3. The fuel cell system according to claim 2,
further comprising a coolant bypass parallel to the power electronics heat exchanger for bypassing the power electronics heat exchanger at least with a part of the coolant flow.

4. The fuel cell system according to claim 3,
further comprising a cathode reactant gas heat exchanger,
wherein the cathode reactant gas heat exchanger is arranged in the cooling loop downstream of the at least one fuel cell heat exchanger and
wherein the cathode reactant gas heat exchanger is adapted for being flown through by air supplied to a cathode of the at least one fuel cell.

5. The fuel cell system according to claim 4,
further comprising a source of compressed air coupled with a cathode side of the at least one fuel cell.

6. The fuel cell system according to claim 1,
wherein the thermal dissipation unit is arranged in a ram air channel.

7. The fuel cell system according to claim 1,
wherein the coolant is a liquid coolant comprising glycol and water.

8. The fuel cell system according to claim 7,
further comprising at least one de-ionization filter arranged in the cooling loop.

9. An aircraft comprising:
a fuselage, and
a fuel cell system arranged in the fuselage.
the fuel cell system comprising:
a power electronics unit for the control and conversion of electrical power of the at least one fuel cell,
a coolant bypass parallel to the power electronics heat exchanger for bypassing the power electronics heat exchanger at least with a part of the coolant flow,
a cathode reactant gas heat exchanger, and
wherein the power electronics unit comprises a power electronics heat exchanger arranged in or at the power electronics unit for receiving heat of the power electronics unit, and
wherein the power electronics heat exchanger is arranged in the cooling loop upstream of the at least one fuel cell heat exchanger,
wherein the cathode reactant gas heat exchanger is arranged in the cooling loop downstream of the at least one fuel cell heat exchanger and
wherein the cathode reactant gas heat exchanger is adapted for being flown through by air supplied to a cathode of the at least one fuel cell.

10. The aircraft of claim 9,
further comprising a ram air channel in the fuselage, wherein the thermal dissipation unit is arranged in the ram air channel.

11. Aircraft of claim 9,
further comprising at least one interior space in the fuselage,
wherein the thermal dissipation unit is arranged in the at least one interior space and is adapted to dissipate heat into the at least one interior space.
